(19) United States
(12) Patent Application Publication
(10) Pub. No.: US 2003/0078865 A1
(43) Pub. Date: Apr. 24, 2003

(54) Automated financial market information and trading system

(76) Inventor: Theodore C. Lee, Irvine, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 10/279,594

(22) Filed: Oct. 23, 2002

Related U.S. Application Data
(60) Provisional application No. 60/345,084, filed on Oct. 24, 2001.

(51) Int. Cl. G06F 17/60

(52) U.S. Cl. 705/35

(57) ABSTRACT

An automated financial market communication apparatus executes actions as desired, and includes a facility for selecting parameters including: event category, event object, object attribute, attribute comparison, and comparison value. These parameters establish a condition or conditions of operation of the apparatus. Actions may be selected and logged for execution given one or another of the conditions. The actions are then executed manually or automatically in managing a financial market portfolio.

### RELATED APPLICATIONS

This application claims priority and is entitled to the filing date of U.S. Provisional application Ser. No. 60/345,084 filed Oct. 24, 2001, and entitled “Instant Voice Alert Based On Global Intelligent Multimedia System (GIMS).” The contents of the aforementioned application are incorporated by reference herein.

### BACKGROUND OF THE INVENTION

### Incorporation by Reference

Applicant(s) hereby incorporate herein by reference, any and all U. S. patents, U.S. patent applications, and other documents and printed matter cited or referred to in this application.

1. Field of the Invention

This invention relates generally to financial market trading systems and software, and more particularly to such a system capable of nested logic changes by a user for automated market trading and broad applicability.

2. Description of Related Art

The following art defines the present state of this field:

The prior art teaches event notification methods, both remotely and locally. As described in U.S. Pat. No. 6,353,861 to Dolin et al. and U.S. Pat. No. 5,621,892 to Cook, teach several methods for communication of events in computer networks. These methods include message passing, remote procedure calls, and data sharing. Interrupt handlers handle system events within a local computer system. An event can be defined as either a synchronous or an asynchronous occurrence or condition that is significant to a computer system or user. Prior art computer systems have implemented event management by hard coding the logic with programming languages. Such configurations break down in a distributed computing environment since there are various computing resources in the network and events may occur at any time from many resources. Dolin et al. describes a programming environment, which allows for event scheduling where events may be any arbitrary condition. However, event scheduling still needs to be programmed and compiled to generate an executable program. Hence, it cannot be done dynamically, and a user cannot change the logic in realtime to accommodate his/her needs.

Adams et al., U.S. Pat. No. 3,573,747 describes an apparatus and method of automatically, anonymously and equitably buying and selling fungible properties between subscribers. The specific embodiment described in the disclosure relates to the buying and selling of securities wherein a communication system pursuant to this invention is described which permits institutional investors to communicate anonymously with each other for the purpose of arranging block trades of listed and over-the-counter securities. Said system comprises a centralized data storage unit, a digital computer, a plurality of subscriber terminals and a plurality of communication links established therebetween. The method of the system comprises the steps of (1) booking unfilled buy offers including associated price and quantity parameters on a buy offer list in a priority sequence according to a first predetermined program (2) booking unfilled sell offers including associated price and quantity parameters on a sell offer list in a priority sequence according to a second predetermined program, (3) comparing in said priority sequence, the price and quantity parameters of each incoming offer with the corresponding parameters of each offer on the complementary one of said lists, (4) transacting said received offer with the higher priority offers on said complementary list if said incoming offer can be matched. against one or more offers on the complementary offer list, and (5) placing the untransacted portion of said received offer on the corresponding one of said lists in a priority sequence according to tire corresponding one of said predetermined programs if said incoming offer cannot be completely matched against offers on complementary offer list.

Toy, U.S. Pat. No. 4,554,418 describes an information monitoring and notification method, which can monitor financial market information and notify users in near real time when interested events occur. The notification can be made via a telecommunication channel by means of a voice-synthesized message. Although Toy describes the invention as automated and near real-time, the actual implementation to produce such results is not efficient and in some cases not very clear. In particular, the way a user can specify a specific condition is not described in detail and appears to be limited to just financial instruments such as stocks, commodities, and futures. In addition, how one adds a functional calculation as part of the condition and how it gets evaluated is not discussed. Therefore, it is believed that each individual condition cannot be entered and/or modified, and then immediately evaluated in near real-time. Furthermore, after a condition is met, the action is limited to a contact list and the results of such contact cannot be fed back to the conditions to provide a more sophisticated nesting structure. This results in system failure to achieve its goal of being near real-time user response and flexible.

Kalmus et al., U.S. Pat. No. 4,674,044 describes a system which retrieves the best obtaining bid and ask prices from a remote database and performs automatic trade executions. Each trade is executed based on a set of predetermined parameters, which includes the bid/ask prices, the amount of stock available, and maximum single order size. This particular prior art appears to be limited to only a small set of pre-determined parameters. The logic in which various trades are executed is also pre-determined.

Wagner, U.S. Pat. No. 4,903,201 describes a computerized open outcry exchange system for transacting sales of a particular futures commodity contract by members of a futures trading exchange wherein bids to purchase or offers to sell the particular commodity contract are made by the members through remote terminals and the exchange computer automatically matches offers and bids to complete the transaction.

Linstroth et al., U.S. Pat. No. 4,942,616 describes an automated price quoting apparatus for customers via a telephone interface. The instructions are inputted via DTMF and the price quotations are reported to the caller in a synthesized human voice. In addition, simple price triggers can be set up by brokers to automatically notify their clients via the telephone interface. Such prior art lacks the sophistication of the current invention and provides limited and inefficient usage of today's technology. In addition to automated price quotation and alerts, the current system provides both speech recognition and a DTMF support to a wide range of information including, but not limited to, account information, price quotes, news information, and placing a trade.

Kehnemuyi et al., U.S. Pat. No. 4,975,841 describes an apparatus to automatically contact customers with order status data such as its product order information, scheduled and actual shipping dates and each customer's telephone number. However, such reporting of customer information is only available at a predetermined periodic time interval or time of day. With the current invention, such limitation is removed allowing the user to use other events as part of the notification conditions such as receiving a call when the product is shipped, which can not be accomplish with the current art without re-programming the apparatus.

Togher et al., U.S. Pat. No. 5,375,055 describes an electronic brokerage system that performs a trade electronically by distributing anonymous price quotes on a selective basis according to each user's credit limit. Such a system appears to be limited to price quoting and credit limit information. In addition, system internal logic specifying how information is determined cannot be changed in real-time.

Cook, U.S. Pat. No. 5,621,892 describes an event management system in which dispatches are provides, in response to an alert based on a pre-configured alert and schedule. The service providers use services such as email, facsimile and printing services. A common programming interface is used in the system to support a wide variety of alerts. However, mapping between the alert and its corresponding service provider uses an elementary if-then relationship. That is, if an alert of such type occurs, then execute the service provider. Both else action and nested if-then-else constructs are missing in the prior art. Furthermore, conditions can not be set up based on an alert and a timer together, but only with the scheduler. The result is that a conditional evaluation cannot be scheduled at a later time, which results in an unnecessary higher CPU utilization if date/time constraints need to be used as part of the conditional evaluation. The current invention overcomes such problems by both allowing the usage of a date/time event in conditions and/or a delay trigger for such.

Lawson et al., U.S. Pat. No. 5,721,825 describes a system for global event notification in a distributed computer environment. A local event registry identifies local event consumers who should be notified when an event occurs. A global event registry identifies other servers that should be notified of the event and these remote servers will then notify their local event consumers of the event. However, as pointed out in Shaffer et al., U.S. Pat. No. 6,094,681, the invention does not solve the problem of remote notification when the user is locally not available to receive the notification. Also, issues of flexibility still exist in this art. Shaffer et al. (see below) describes a system to solve such problems by providing automatic event notification to a remote user via a telecommunication system when the user is determined to be unavailable to locally receive notification. The remote notification capability includes wired/wireless telephone, wireless pager, and/or a personal digital assistant (PDA). However, the data filter appears to be rudimentary. The examples given for the data filter are only for stock price, email, and appointment notifications. Also, notification sequence is limited and restricted to audio alarm, screen pop-up, and telecommunication notifications.

Matsubara et al., U.S. Pat. No. 5,926,801 describes a dealing system that performs a trade electronically between the buy and sell side of financial orders. This prior art claims to have the system automatically setting a margin price relative to a last trade price and calculating a decision price based on the last price. The notification is done through a simple audio alarm on the user's computer. The invention appears to be pre-programmed with most of the logic for such an automatic trade matching system. However, it does not offer any flexibility to do any real-time modification of the logic. The notification method is straightforward and unsophisticated.

Elston, U.S. Pat. No. 6,055,505 describes a method to automatically notify a customer of an event using a telecommunication system. However, the triggering condition of an event is fairly simple and is not very flexible. Any changes to the triggering condition will require re-program of the logic.

Shaffer et al., U.S. Pat. No. 6,094,681 describes a system to solve this problem by providing automatic event notification to a remote user via a telecommunication system when the user is determined to be unavailable locally. The remote notification capability includes wired/wireless telephone, wireless pager, and/or a personal digital assistant device. However, the data filter appears to be rudimentary. The examples given for the data filter are only for stock price, email, and appointment notifications. Also, notification sequence is limited and restricted to audio alarm, screen pop-up, and then followed by telecommunication notifications.

Rickard et al., U.S. Pat. No. 6,112,189 describes a system that automates the process of trade negotiation between multiple parties based on a set of decision variables and functions. The invention claims to solve the negotiating problems without revealing a party identity and positions to each other. Unfortunately, such decision variables and functions are all pre-determined by the system and cannot be changed. Any changes will require lengthy reprogram of the system.

Gladstone, U.S. 2002/0004776 A1, describes a method of receiving trade trigger criteria and market data for use by market analysis software. The method claims to be flexible in nature such that each subsystem can be located at different physical locations and thus maintained by different entities. However, the method fails to clarify how trade triggers are entered and trade decisions achieved with the use of its trade trigger. It leads one to believe that modifications of its trade triggers cannot be done in real-time and is limited to certain trading algorithms. Such a method is also limited to trade execution only. It cannot generate a trade alert or a notification.

Shapiro, U.S. 2002/0091606 A1, describes a predictive automated trade routing system whereby a user creates a best execution profile that can be matched with statistical trading parameters such as execution speed, price improvement, and liquidity improvement. Although the prior art provides a method to capture one type of user intent, the domain for such application is limited to only trade routing based on limited statistical parameters. Any additional parameters will require additional programming and results in longer updates of user intent. The present invention can achieve dynamic trade routing based on those statistical parameters, but with flexibility and ease once those parameters are enabled in the system. The actual logic for comparing user profile with historical data is controlled by the user instead of the programmer since there is no programming involved for adding additional logic and parameters in the system.

The present invention improves the inefficiencies and limitations associated with many prior art systems and methods for automated event notifications and executions. First, contrary to the prior art, the present system does not require any computer programming, yet achieves the complexity that is required for sophisticated trade strategies and event planning. Second, the scope of the system is dynamic and can be extended easily to a greater problem domain than is possible with prior art systems and methods. Third, using unlimited nested constructs, the current invention enables the user to create feedback for each conditional evaluation, which enables user intent at a significantly higher level than is possible in prior art systems. The applications to which the present invention may be applied are numerous and can vary according to personal preference.

### SUMMARY OF THE INVENTION

The present invention teaches certain benefits in construction and use which give rise to the objectives described below.

There has been a rapid advance in computer capabilities in the last two decades. A computer's processing power continues to grow and to become less expensive. However, the ability to sift through ever larger amounts of information to find key decision making factors is a growing problem as the amount of available information grows exponentially. The present invention provides a means for using if-then-else logic, well known in computer programming, to user applications in filtering information to achieve an objective quickly, ostensibly, in “real-time.” The present invention provides a means by which directions may be communicated for executing actions remotely and with full automation.

An important application of using such a system is in the area of financial investment, where market fluctuations are fast-moving and the amount of information is intensive. The ability to react quickly to changing market conditions often means the difference between investment gain and loss.

A primary objective of the present invention is to provide an system and method of use of such system that provides advantages not taught by the prior art.

Another objective is to provide such an invention capable of being easily and quickly adapted by a user.

A further objective is to provide such an invention having of a wide range of adaptive features including full automation.

A still further objective is to provide such an invention capable of being used with all known communication means for true remote capability.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The drawings provided herewith illustrate a preferred embodiment of the present invention only, and are not to be considered as limiting the scope thereof. The features and the advantages of the present invention will be apparent from the discussion below taken in conjunction with the accompanying drawings, in which:

FIG. 1 is a block diagram illustrating the apparatus of the present invention;

FIG. 2 is a block diagram condition parameters thereof;

FIG. 3 is a block diagram of action parameters thereof;

FIG. 4 is a pictorial representation of a graphical interface thereof; and

FIG. 5 is a logic processing flow chart illustrating data processing for monitoring and executing a nested IF-THEN-ELSE logic.

### DETAILED DESCRIPTION OF THE INVENTION

The present invention provides an improved apparatus and method for event management in a distributed computer environment. The above described drawing figures illustrate the invention in at least one of its preferred embodiments, which is further defined in detail in the following description.

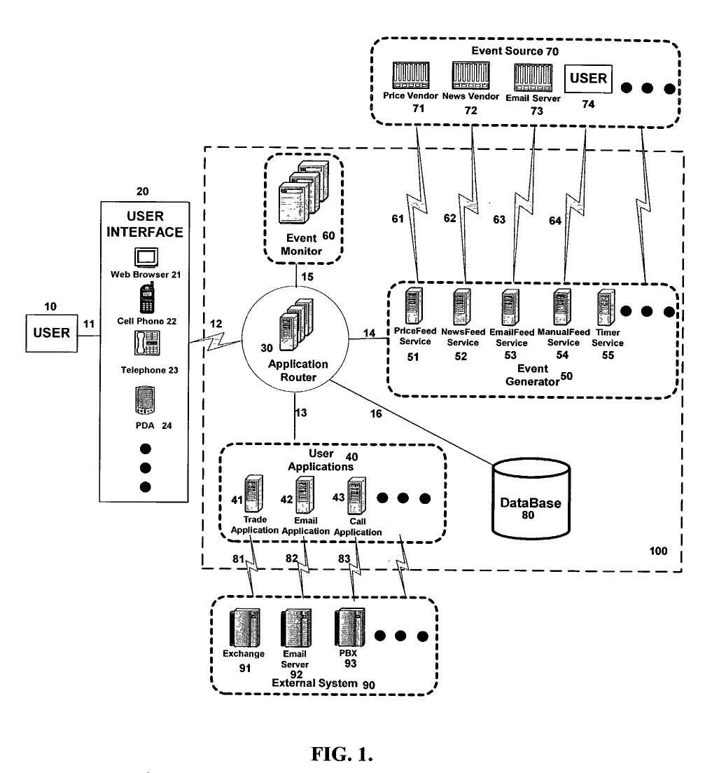

An application of the present invention is a financial market trading system providing market information to a user and enabling the user to direct market moves remotely and with automation. FIG. 1 shows the preferred configuration of the system. Herein below, the system comprises of a user 10, communication devices 21-24, communication channels 12, 61-64, 81-83, software programs 30, 40-43, 50-55, 60, commercially available databases 80, computer network arrangements 13-16, such as local area networks (LANs), wide area networks (WAN), Internet, and many other common forms of computer communication mediums, and computer systems 70-73, 80, 90-93. All elements inside the dotted square 100 are considered as internal to the system and everything else is external-to the system.

A user 10 communicates with a computer user interface 20 and is able to create or change the logic profile or configuration used for him/her. Such user 10 can be a private or individual investor, a broker/dealer, a broker/dealer trading desk, an institutional investor, or anyone interested in trading a security. The user interface 20 can be one of the popular communication devices, such as web browser 21, cell phone 22, wired telephone 23, Personal Digital Assistants (PDA's) 24, and many others. The user request for creating or changing the logic profile is communicated through each communication channel 12 to an application router 30. The application router 30 then routes the request to event monitors 70, services 51-56, part of event generator 50, database 80, and applications 41-43, etc., part of user applications 40. Each user request for creating a logic profile is registered in event monitor 60 and stored for persistence in database 80. After register the logic successfully in event monitor's computer memory, the event monitor then finds the corresponding event generator and subscribe for a particular event object. Event sources 70 such as price vendor 71, news vendor 72, email server 73, the user him/herself 10 (shown as numeral 74) and others, communicate with the event generator 50. There are, however, event generators that are internal to the system (i.e., without communication with an external event source 70), such as a timer service 55. Timer service 55 will trigger an date/time event on certain date and time. The main purpose of an event generator, besides receiving events from its source, is to filter tens of thousands of unwanted events and forward only the interested events to event monitor for comparison. This will reduce the otherwise enormous load on application router 30 and affecting the overall performance of the system. Different user applications 40 provide different services to satisfy user's needs. The trade application 41 can manage one's portfolio/accounts, and provides trading capabilities. The email application 42 can send/receive emails and manage them. The call application 43 can either receive an inbound telephone call from a user or place an outbound telephone call to a user. More user application can be easily added to the system without affecting the overall structure of the apparatus. Each user application communicates with one of the external systems 90, which comprised of a wide range of services such as financial exchange 91, email server 92, telephone PBX 93 and others. As can be seen in FIG. 1, the user 10 communicates with the system in two ways; first by establishing the user interface 20, a set of logic and information by which the system knows how to interface with the user 10. This interface 20 may be changed dynamically by the user 10 at anytime and anywhere, and second, the user 10 communicates with the system via communication link 64 to manual feed service 54. In the latter communication the user 10 is able to direct actions on his/her own behalf in real time, i.e., immediately.

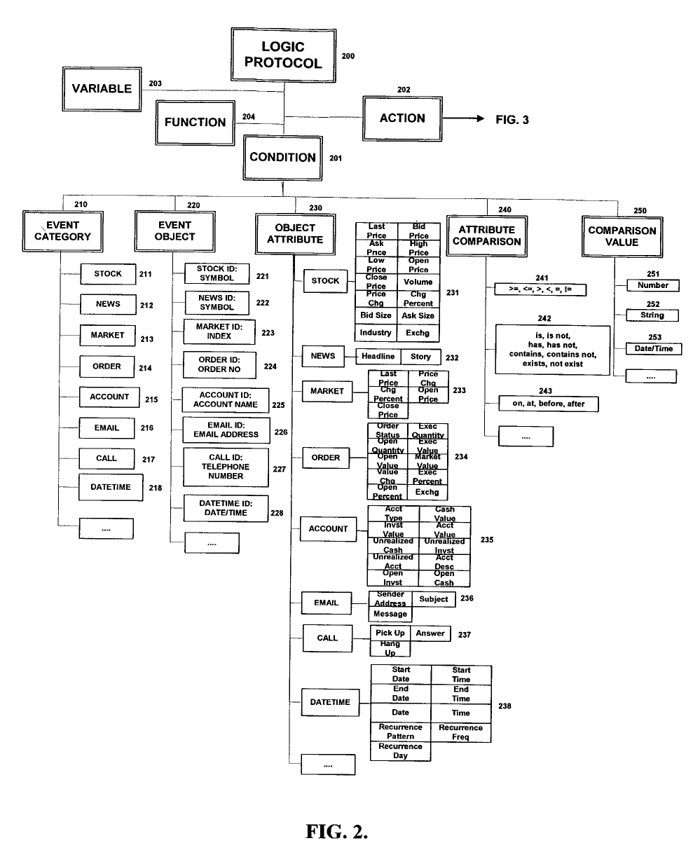

FIG. 2 illustrates the hierarchical structure of all elements in a logic protocol. The basic logic protocol 200 has two parts: condition 201 and action 202. The system enables the user to select certain parameters as part of the condition (shown in bold print), re: event category 210, event object 220, object attribute 230, attribute comparison 240, and comparison value 250. These parameters work in a programmed logic protocol to execute a sequence of user approved actions automatically, or by user direction. In the following, the above identified parameters are defined.

The event category 210 describes the system domain, that is, the types of events that the system can support. The system supports eight choices in these event categories which are not exhaustive of such possible choices. These choices are: stock 211, news 212, market 213, order 214, account 215, email 216, call 217, and datetime 218. Each event category 210 selection corresponds to an event generator, which is defined such that it generates an event occurrence whenever the chosen event category 210 occurs in real time by either an external or internal event source, or even an user application. For example, a server, which we shall call “PriceFeed” service 51 in FIG. 1 provides real-time price information from various financial exchanges. When a bid/ask price of a stock is updated in its market, a price event is generated and sent to the system for comparison.

Next, an event object 220 is chosen. The event object 220 determines which event is monitored. For example, the user might be interested in the price of the IBM stock share. This helps the system to filter thousands of stock symbols in the market and monitor only the interested stock symbol. Each event category 220 has either its own object identifier or ID, which uniquely identifies the object, or can be quantified generically as “<ANY>”. In this system, the chosen identifiers are: stock symbol 221 for stock, stock symbol 222 for news, a market index 223 for market, an order number 224 for order, an account name 225 for account, an email address 226 for email, a telephone number 227 for call, and a specific date/time 228 for datetime.

Next, an object attribute 230 is chosen. This parameter is the attribute of the interested event object 220 that is used for comparing with the event generator 50. There are many unique attributes for each event object 220. Each attribute describes the event itself and acts as an input parameter for the user to define each event object 220. For example, the attributes for a stock object are: a last price, a bid price, an ask price, a high price, a low price, an open price, a close price, a volume, a price change, a price change percent, a bid size, an ask size, an industry and an exchange 231. The attributes for a news object are: a headline and a story 232. The attributes for a market object are: a last price, a price change, a price change percent, an open price, and a close price 233. The attributes for an order object are: an order status, an executed quantity, an open quantity, an executed value, an open value, a market value, a market value change, an executed percent, an open percent, and an exchange 234. The attributes for an account object are: account type, cash value, investment value, account value, unrealized cash value, unrealized investment value, unrealized account value, account description, open investment value, and open cash value 235. The attributes for an email object are: a sender's email address, an email subject, and an email message 236. The attributes for a call object are: pick up, answer, and hang up 237. Finally, the attributes for a datetime object are: a start date, a start time, an end date, an end time, a date, a time, a recurrence pattern, a recurrence frequency, and a recurrence day 238.

Attribute comparison 240 is the comparison operator that causes a comparison to be made between the attribute of the selected event object 220 and the event forwarded by the event generator 50. The result of such comparison is true or false. Each attribute comparison has different comparison operators. For numerical comparison such as price, volume, etc., the numerical relational and equality operators are used: >=, <=, >, <, =, and !=241. For string comparisons such as exchange, industry, etc., the string comparison operators are used: is, is not, has, has not, contains, contains not, exists, and not exist 242. For date/time comparison such as start date, start time, etc., the date/time comparisons are used: on, at, before, and after, 243. Comparison value 250 is the actual value that is being compared between the attribute of the interested event object 220 and the value of the forwarded event from the event generator or user application. Each comparison value can be either input with a value or selected from a list of available choices. The value can be an integer or floating number 251 (such as 55 or 0.234) used in numerical comparison, a string 252 (such as ‘NYSE’ or ‘earning news’) for a string comparison, or a date/time format 253 (such as ‘10/24/2002’ or ‘10/24/2002 10:00 A.M.’). Condition 201 is a construct of all of the aforementioned parameter categories, i.e., event category 210, event object 220, object attribute 230, attribute comparison 240, and the comparison value 250, when comparing an event from the event generator to evaluate either the true or false state. Once constructed, each condition can be used to construct more complex conditions using logical AND, OR, and NOT operators.

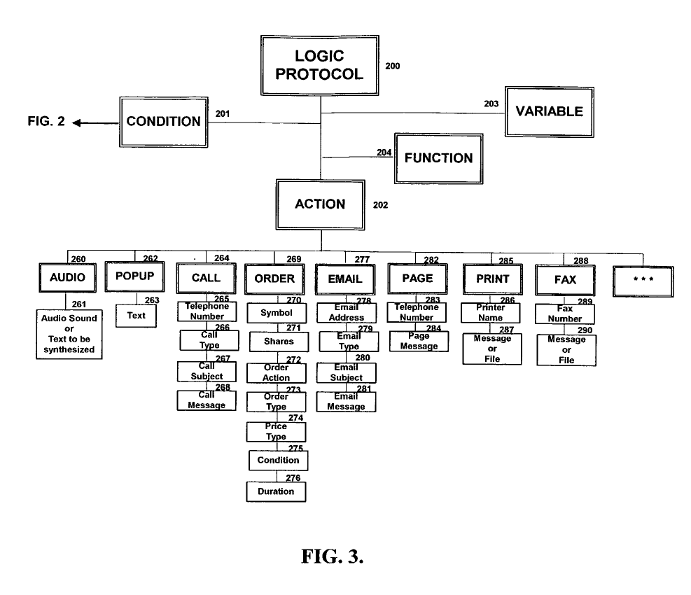

Referring to FIG. 3, action 202 is a single action event that the user wants to execute once all the conditions have been determined to be true. Examples of these actions include: audio 260, popup 262, call 264, order 269, email 277, page 282, print 285, and fax 288. Each action requires its own parameters to be defined in order for the system to execute the action successfully.

For an audio action event 260, user has a choice to specify what text the system will synthesize through its text-to-speech engine or playback through an audio file 261. The default can be a simple ‘ding’ sound at the computer terminal. Such action event is known in prior art.

For a popup action event 262, user has a choice to specify what text 263 the system will put in the window popup at the computer terminal once triggered. Such action event is known in prior art.

For a call action event 264, the user specifies a telephone number 265, a call type 266 such as notify, yes/no, interactive, call subject 267, and a call message 268. As an alternative to the call subject 267 and call message 268, user can personalized the call by specifying a pre-recorded voice file. The telephone number 265 can be either selected from a pre-determined list, e.g., a home phone, cell phone, company phone, etc., or entered with a new number. Multiple telephone numbers are accommodated, and the sequence of how each number is dialed can be set by the user. The call type 266 is used to distinguish how the call will be played and answered by the user once receiving the call. A notify call is one that the system just simply plays the subject text and call message via a synthesized voice or a voice file and ends the call. A yes/no call is one where after playing the subject and message prompts, the system asks the user a pre-determined question. The answer to such question may be used in a nested condition to be evaluated later. An interactive call is one where after playing the subject and message prompts, the system places the user into a dialog state where the user is able to ask the system for additional information such as account information, stock quotes, etc. Call subject 267 is used to indicate to the receiver what the call is about. Call message 268 is the actual message that the user wants to send to the receiver. Both call subject 267 and call message 268 can be either defaulted to a system generated message or can be specified by the user. For security, the system can prompt the user for his/her pin before playing the prompts and allowing him/her entering into the system.

For an order action event 269, the user specifies the required parameters associated with each trade. For a stock trade, the parameters that need to be specified are: the symbol to be traded 270, number of shares 271, order action (buy/sell/sell short) 272, order type (market, limit, stop, stop loss) 273, price type (last, bid, ask, open, close, or a specific price) 274, order condition (none, all or none, fill or kill) 275, and order duration (day or good until canceled) 276. There are different parameters for different types of trades such as option, futures, mutual fund, etc.

For an email action event, the user specifies an email address 278, an email type 279 such as notify or reply, an email subject 280, and an email message 281. As an alternative to the email message, user can specify a text file attachment. Such text file can be any document type supported by the user's email server. An example of such file could be a trade ticket. The email address 278 can be either selected from a pre-determined list or entered with a new address. Multiple email address can be entered, and the sequence of how each email address is sent can be determined by the user. The email type 279 is used to distinguish how the email will be sent and replied to by the receiver once receiving the email. A notify email is one in which the system merely sends the email message to the receiver with a subject and message. A reply email is one where the system expects a reply for the message sent and has an option to resend the email periodically if no reply is received. When the receiver replies, it can be used as a condition to be evaluated later for triggering possible further action. Email subject 280 is used to indicate to the receiver what the email is about. Email message 281 is the actual message that the user is sending to the receiver. Both the email subject 280 and the email message 281 can be either defaulted to a system generated message or can be specified by the user.

For a page action event 282, user specifies a pager telephone number 283, and a page message 284. The pager number 283 can be either selected from a pre-determined list or entered with a new number. Multiple pager numbers can be entered, and the sequence of how each number is dialed can be determined by the user. The page message 284 can either be entered or via a text file.

For a print action event 282, user specifies a printer name 286 that is connected to the computer, and the message to be printed 287. The printer 286 can be either the default printer for the computer or selected from a pre-determined list of available printers. Multiple printers can be entered so different printers can be printed to. As an alternative to the print message, user can specify a text file attachment. Such text file can be any document type supported by the user's print server. An example of such file could be a trade ticket.

For a fax action event 288, user specifies a fax number 289, and the message to be faxed 288. The fax number 289 can be either selected from a pre-determined list or entered with a new number. Multiple fax numbers can be entered so different fax numbers can be sent to. As an alternative to the fax message, user can specify a text file attachment. Such text file can be any document type supported by the system's fax server. An example of such file could be a trade ticket.

If-then-else logic uses logic statements using a set of conditions for the ‘if’ conditional evaluation and execute, the ‘then’ action list if the evaluation is true, and the ‘else’ action list if the evaluation is false. Such logic programming is well known.

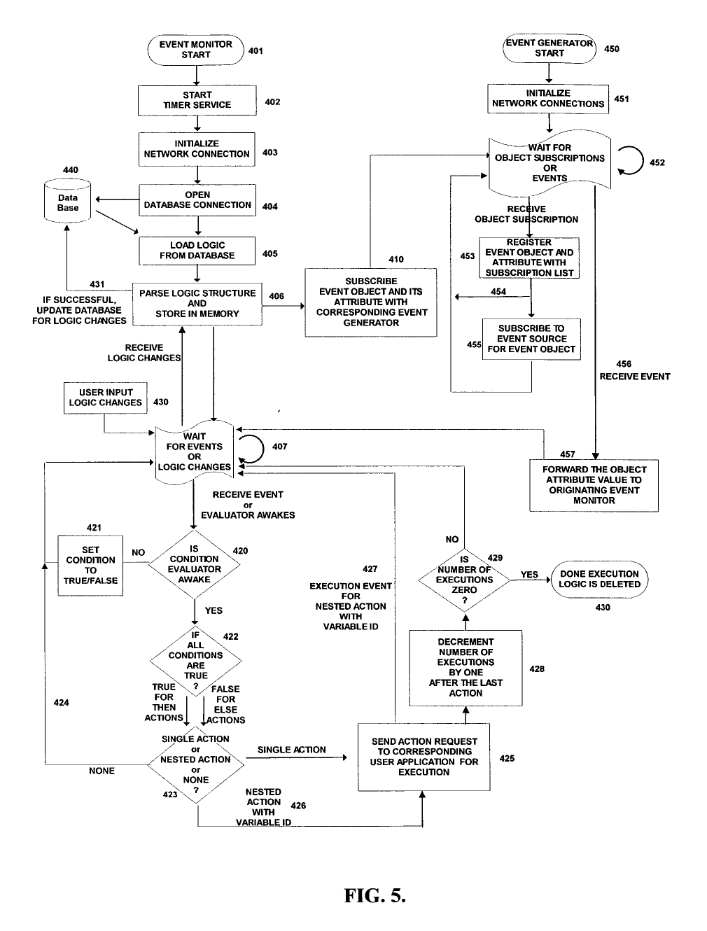

Nested if-then-else logic has a nested logic statement that includes a simple logic statement with additional conditions evaluating the result of other actions. This is accomplished using one of the object variables 203, which provides the reference to an earlier action. Further explanation of such variable is provided below in FIG. 5. The present invention logic protocol using such nested statement logic conditions to manage all possible trade information transfers and responses.

To create even more complex relationships among conditions and actions, one can define a function 204. A function can be a mathematical equation or model that describes the relationships between any condition and action parameters. All well-known mathematical operators: add, subtract, divide, multiply, as well as mathematical functions: power, square root, log, absolute value, trigonometric functions—sin, cos, tan, etc, are available. An example of this could be to define a mid price of a stock as the sum of bid and ask divided by 2, and use the mid price as part of the conditional evaluation.

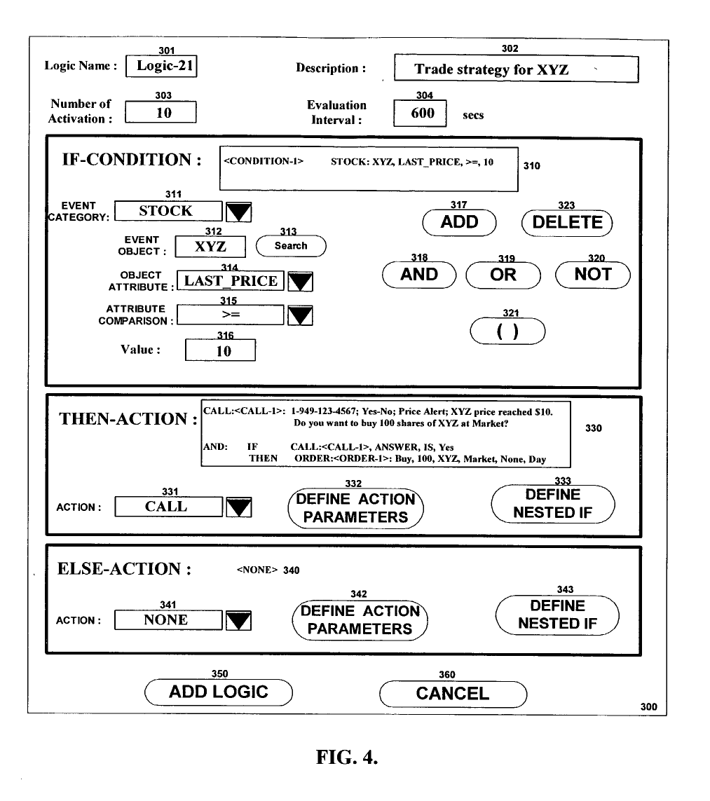

FIG. 4 shows the user display 300 for adding a nested if-then-else logic. Once displayed, a unique name 301 for the logic can be either entered by the user or defaulted by the system. The user can enter a description 302 for the logic, which can be used for mnemonic searches later. Each logic can have any number of conditional evaluations and action executions and is controlled by the number of activations field 303. One can also specify a negative number to allow the system to continuously process the logic until either being suspended or reset by the user. Evaluation interval 304 determines how often each condition gets processed by the system. This is useful for avoiding too frequent evaluation of each condition, which can result in degradation of overall performance of the system in addition to produce possible unwanted results. For example, receiving a phone call every 10 seconds notifying about the market condition would not be desirable for most of the users. In such case, the system might warn the user about potential problem if the evaluation interval is below certain threshold, such as 60 seconds.

After entering the general information about the logic, user is directed to select an event category 311, which has been described earlier 210 in FIG. 2. In fact, all the fields on the display have been described in FIG. 2 and in the earlier paragraphs. Selecting one of the event categories 311 such as stock, allows one to define the type of events the user is interested for evaluation. Next, an event object 312 is chosen to uniquely identify the interested event within the event category. Stock symbol XYZ 312 is entered by the user in FIG. 4. Alternatively, user can enter the keyword “<ANY>” in event object field 312 to indicate that price events of any stocks will get evaluated. As a further alternative, the user can search for an object identifier by selecting the search button 313. Once pressed, the system lists all possible objects in the chosen event category. Different search criteria can be entered to narrow the search space. For example, the stock symbol can be look up by entering a partial or full name of the stock's company name. Object attribute 314 is selected to define which attribute of the event object 312 is used in the condition evaluation. The attribute comparison 315 varies depending on the type of the object attribute 314 selected. For numerical comparison, the numerical relational and equality operators, >=, <=, >, <, =, and !=241 are available. For string comparisons, the string comparison operators, is, is not, has, has not, contains, contains not, exists, and not exist 242, are available. For date/time comparison, the date/time comparisons, on, at, before, and after 243, are available. Comparison value 316 is the actual value that is being compared between the attribute of the interested event object 312 and the value of the forwarded event.

After defining all the parameters for the condition, user can select the “ADD” button 317 to add the condition to the if-condition evaluation list 310. Each condition can be combined with additional condition with logical operator “AND” 318 and “OR” 319. To negate a condition, user can select the condition first and then select the “NOT” operator 320.

Selecting the logical operator “AND” operator 318 in the condition list will toggle to the “OR” operator 319 and vice versa. Selecting the “NOT” operator will remove the “NOT” operator. In addition, to specifying the order of evaluation of more complex conditions, parenthesis 321 can be used. For example, in a condition set “A AND B OR C,” selecting A, B and “( )” results in “(A AND B) OR C” and selecting B, C and “( )” results in “A AND (B OR C).” Parentheses can be deleted by selecting the parentheses and the delete button 323. User can delete any condition in the list by selecting the condition first and then selecting the “DELETE” button 323. Condition-1 310 in FIG. 4 reads “If the stock XYZ's last price is greater than $10.”

Once the desired conditions are defined, a list of actions is specified in the “THEN-ACTION” field 330 or the “ELSE-ACTION” field 340. Selecting an action in the action list 331 requires one to define its parameters 332. Such parameters have been described in FIG. 2 and earlier paragraphs. Nested if-conditions can be added by selecting the “NESTED-IF” button 333. Selecting the “NESTED-IF” button 333 brings up the same user interface display 200. This allows the user to add any number of logic elements in the nested structure that is restricted only by event monitor's 60 computer resources such as its memory and CPU. The result can be a complex decision tree structure. Each action will have a variable 330 associated with it (e.g., “CALL-1”) so it can be referred to in a nested if conditions. The same can apply to the “ELSE-ACTION” fields 341, 342, and 343. The then-action 330 in FIG. 4 reads “then call the telephone number 1-949-123-4567 with a ‘yes/no’ price alert question about whether to buy 100 shares of XYZ at market. If user picks up the phone and answers ‘yes’ to the question, then system automatically place the order with the pre-defined parameters.” Once defined, user can add the logic to the system by selecting the “ADD LOGIC” button 350. Selecting the “CANCEL” button 360 merely exit the user interface without adding the logic.

In order to better understand the advantages of the present invention, the followings are a few more examples of how a user may utilize the same.

Example 1: A client of ABC Firm is authorized to trade on the system provided by the current invention. The client likes stock XYZ at $40 per share, $6.25 below its current price. Thru technical analysis, the client determines the Dow Jones Industrial Average must be at 9500 for Stock XYZ to attain that price. Alternatively, the client determines that it's a buy signal if stock XYZ stays below $40 at closing for three days. Once a buy signal is reached, the client wants to receive a notification at his cell phone 1-714-555-1234, and decides at that time whether to buy 200 shares of stock XYZ at market. If a trade order is entered, the client wants to be notified about the traded price and shares bought and at same time notify his broker at 1-714-555-2222 about such trade.

Using the interface shown in FIG. 4, the client then enters the following nested if-then-else logic:

IF ((STOCK:XYZ, LAST_PRICE, >=, 40)

AND (MARKET:DJIA, LAST PRICE, >=9500))

OR ((STOCK: XYZ, CLOSE_PRICE, <=, 40)

AND (DATETIME: <ANY> date/time, Recurrence Pattern, is, ‘Daily’)

AND (DATETIME: <ANY> date/time, Recurrence Frequency, is, 3))

THEN [CALL:<CALL-1>, 1-555-1234, Yes-No, Price Alert, “Dow is at 9500 and XYZ is at $40 or stock XYZ has been staying below $40 at closing for the last three days. Do you want to buy 200 shares of XYZ at Market?”]

AND IF (CALL:<CALL-1>, ANSWER, Is, Yes)

THEN [ORDER:<ORDER-1>, buy, 200, XYZ, Market, None, Day]

AND IF (ORDER:<ORDER-1>, ORDER_STATUS, is, Fully-Executed)

THEN [CALL: <CALL-2>, 1-555-1234, 1-714-555-2222, Notify, Trade Execution, ‘Executed shares is <ORDER-:$EXECUTED_QUANTITY> and its price is <ORDER-1:$EXECUTED_PRICE>’]

Note, that <CALL-1> and <ORDER-1> are object variables that refers to the particular call and stock order placed. They can be used in other conditions for evaluation of the results of the corresponding actions. System variables such as <ORDER-1:$EXECUTED_QUANTITY> and <ORDER-1:$EXECUTED_PRICE> can be used as part of the prompt to be filled in by the system's value at the time of the execution.

Two weeks later the client is playing golf at his/her country club and is on the 12^{th} hole. The conditions previously entered in the system are met and he/she receives a call on his/her cell phone and authorizes the purchase for an account of 200 shares of XYZ at the market and continues playing the hole. A few minutes later on the 13^{th} tee box he/she gets a call from the system with notification that the trade was completed and simultaneously his/her stockbroker at ABC firm is notified of the transaction as well.

Example 2: A stockbroker with ABC Firm has identified a security, EFG. EFG has been trading between $15 and $21 per share and is very volatile. The broker has 15 sophisticated clients who might be interested. The broker wants to enter a Stop Loss on each purchase at $13.50. The broker calls all the clients and gets approval to enter for each of them the following instruction: If EFG is at $15, then call the client's phone number, and buy 100 shares of EFG for each client. At the same time, enter a Stop Loss order at $13.50 to protect the loss. Once the buy order is fully executed, notified the user about the buy order trade and the stop loss order status.

Using the interface shown in FIG. 4, the broker then enters the following nested if-then-else logic:

IF (STOCK:EFG, LAST_PRICE, >=, 15)

THEN [CALL:<CALL-1>, <$Active Client Group>, Yes-No, Price Alert, “EFG is at $15.

Do you want to buy 100 shares of EFG at market? After trade is executed, a stop loss of $13.50 will be entered also”]

AND IF (CALL:<CALL-1>, ANSWER, Is, Yes)

THEN [ORDER:<ORDER-1>, buy, 100, EFG, Market, None, Day]

AND [ORDER:<ORDER-2>, sell, 100, EFG, stop loss, stop price, $13.50, None, Day]

AND IF (ORDER:<ORDER-1>, ORDER_STATUS, is, Fully-Executed)

THEN [CALL:<CALL-2>, <$Active Client Group Who Answered>, notify, Trade notification, ‘Executed shares is <ORDER-1:$EXECUTED_QUANTITY> and its price is <ORDER-1:$EXECUTED_PRICE>. A stop loss order was entered at $13.50. Its current status is <ORDER-2:$ORDER_STATUS>’]

The stock reaches the predetermined price, all of the clients are simultaneously notified by the system. If the client acknowledges the call with a ‘yes’, the buy order will be executed. This will act as a trade confirmation. Those who enter the trade will concurrently enter a Stop Loss order at $13.50 to protect them after the trade is executed. Immediately the clients and the broker are each notified of the execution of the trade, and the placing of the Stop Loss order. Note, the active client group who answered will be determined by the system via its object variables.

Example 3: A venture capital investor invested $250,000 in a new company XYZ and has 1 million shares. The investor also sits on the Board of Directors and is consider as an insider of the company XYZ. The investor has held the stock for 2 years, can sell at most 10% of his shares for each transaction. The investor wants to sell all 10% at $2 per share to recoup original investment at the 4^{th} Friday of each month for the next four months. Once executed, both the investor at 1-714-555-1234 and broker at 1-714-555-2222 are notified of such transaction. A copy of such transaction is faxed to both the legal department of company XYZ at 1-714-555-1234 and United States Securities and Exchange Commission (SEC) at 1-714-555-2222 for compliance.

A known SEC Rule 10b5-1 authorizes an insider of a company to sell if:

1) enters into a contract to sell,

2) specifies the amount of securities to be sold, the date and the price, and

3) may not alter or deviate from the contract in any way.

The venture capital investor and his financial broker enter into a contract and enter into the system the following nested if-then-else logic:

IF (STOCK:XYZ, LAST_PRICE, >=, 2)

AND (DATETIME: <ANY> date/time, Recurrence Pattern, is, ‘Monthly’)

AND (DATETIME: <ANY> date/time, Recurrence Frequency, is, 4)

AND (DATETIME: <ANY> date/time, Recurrence Day, is, ‘Friday’)

AND (DATETIME: <ANY> date/time, Start Date, is, ‘11/01/02’)

AND (DATETIME: <ANY> date/time, End Date, is, ‘2/28/03’)

THEN [ORDER:<ORDER-1>, sell, 0.10* <Stock Account:$STOCK_OWNED(XYZ)>, XYZ, Market, None, Day]

AND IF (ORDER:<ORDER-1>, ORDER_STATUS, is, Fully-Executed)

THEN [CALL: <CALL-1>, 1-555-1234, 1-714-555-2222, Notify, Trade Execution, ‘Executed shares is <ORDER-1:$EXECUTED_QUANTITY> and its price is <ORDER-1:$EXECUTED_PRICE>’]

AND [FAX: <FAX-1>, 1-714-111-2222, 1-714-333-4444, <Trade Ticket File>]

FIG. 5 depicts the processing steps of event monitor and its related event generator of a user's logic profile. When event monitor starts up 401, it starts up its internal timer service 402 for the condition evaluator which provides the interval evaluation of the conditions. It also establishes its network connection services 403 with the application router 30. Once connected with the application router 30, it tries to open a connection to the database 440. Once a database connection is established 404, it then starts to load user logic 405 from the database to the event monitor's memory where the number of remained activations is greater than zero and for those that are not suspended by the user. The condition part of each logic protocol is parsed and each parsed condition parameter is stored in event monitor's memory 406. For a nested logic, the parsing is done initially only to the first level of conditions, only which is necessary to carry out the immediate condition evaluation. The action part of a condition is not parsed until all conditions of the first level are satisfied. When that happens, the parsing of the action is done only to extract its action type. Once the action type is determined, the entire non-parsed action protocol is sent to the corresponding user application responsible for executing such action. This has the benefits of performance improvements and provides service independence among the servers. Once condition parameters of the logic are successfully parsed, each parsed event object along with its attribute is registered with the corresponding event generator by storing the parameters in event generator's subscription list 410. Referring back to FIG. 1, for stock and market objects, the registration is done with the ‘PriceFeed’ service 51. News object is registered with the ‘NewsFeed’ service 52. Account object is registered with the Trade application 41. Email object is registered with the ‘EmailFeed’ service 53. Date/time object is registered with the timer service 55. Order objects are usually involved in nested logics and are handled by trade application. Call objects are handled by call application. After completing such registration with each event generator, the event monitor starts up its main wait loop 407 and wait for any events to occur including any changes to the user's logic profile.

Logic management tools can be entered by user at any time even while the logic is being evaluated. The management tools include adding a new logic, modifying existing logic parameters, deleting an existing logic, suspending the evaluation of a logic, or resuming a suspended logic 430. In the case of adding a new logic, it has a similar processing step as loading the logic initially from the database 406. Once processed successfully 431, the new logic is inserted into the database 440 for persistence in case event monitor needs to re-start again later. Modifying an existing logic updates the logic in the database only after it's parsed correctly. The event monitor essentially treats such operation as two steps: first, delete the logic in memory and then adding a new logic back into memory. Deleting an existing logic removes all execution instances of the logic and from the database. It is possible for system to still execute part of the action list if either modify or delete command are not received in time before the action execution is carried out.

Referring to FIG. 5, the event generator starts up 450 and connects to application router and its corresponding event source 451. Once those connections are established, the event generator starts up its main wait loop 452 and wait for any new incoming subscription requests from event monitor as well as any events received from event source. When an object subscription request is received, the event generator save the relevant information such as the address of the event monitor, logic name 301, event object ID 221-228, and the interested object attribute 231-238 in its memory 453. The event object ID is the index into the hash table that contains the information so it can be compared with incoming events from either the external or internal event source. The event generator then goes back into its main wait loop 454. Hash table exists for information lookup in prior arts. In the case that an external event source requires information to filter the data sent, event generator simply forwards the subscription information to it 455. This further eliminates many unwanted events coming from the external event sources. Once an event is received from the event source 456, the subscribed attributes of the event are forwarded to its original requesting event monitor 457.

When such information is received from its generator, event monitor immediately processes the event. Event monitor extracts the logic names that such event is pertaining to and compares the received attribute data with its target value using its comparison operator. The true/false state is saved to each condition 421. If the condition evaluator is awake, then all other conditions within the if-condition are also evaluated 420. If not, then event monitor goes back into its main wait loop 407 and awaits new events to be received. If all conditions within the if-condition set are true 422, then the then-action part of the logic is parsed and executed. Otherwise, the else-action part of the logic is parsed and executed. If there are no actions associated with either the then-action or else-action 424, the event monitor continues to wait for new events in the loop 407. The parsing of the action part is done by identifying each action as either a single action or a nested action 423. A nested action is an action which has conditions associated with the results of the action. The nested action is identified with an action variable ID. For example, an action variable ID for a call action can be ‘CALL-1’, ‘CALL-2’, etc. Single actions are executed immediately by forwarding the action parameters to its corresponding user application 425 and removed from the action list once completed. Nested actions are treated differently. First, the action is also executed immediately but its associated variable ID is forwarded to the user application as part of the execution 426. Second, the variable ID indicates to the user application that the results of the action need to be sent back to the event monitor 60 for further processing. This is done after the action is fully executed 427. Third, for a condition refers to a variable ID that is assigned to a previously executed action, event monitor tries to locate that variable and evaluate the condition. Whenever a top-level list of actions is completely executed, the number of activations is reduced by one 428. This helps to keep track of the number of executions. When the number of executions reaches zero, the logic is done evaluation and is permanently removed from the memory 430. Otherwise, the logic continues to be evaluated and executed until the number of executions reaches zero 429. Setting the number of executions to greater than zero again requires the event monitor to reload the logic from the database.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An automated communication apparatus for executing actions in a financial market, the apparatus comprising: a means for selecting parameters including: event category, event object, object attribute, attribute comparison, and comparison value; the parameters comprising a condition; and a means for selecting at least one action from a plurality of actions; the condition and at least one action, functional for achieving a communication result.

2. The apparatus of claim 1 wherein the event category is selected from a group of event categories comprising: (a) stock; (b) news; (c) market; (d) order; (e) account; (f) email; (g) call; and (h) date/time.

3. The apparatus of claim 1 wherein the event object is selected from a group of event objects comprising: (a) stock symbol; (b) news symbol; (c) market index; (d) order number; (e) account name; (f) email address; (g) telephone number; and (h) date/time.

4. The apparatus of claim 1 wherein the object attribute is selected from a group of object attributes comprising: (a) stock; (b) news; (c) market; (d) order; (e) account; (f) email; (g) call; and date/time.

5. The apparatus of claim 4 wherein the stock object attribute is selected from a list comprising: last price, ask price, low price, close price, price change, bid size, industry, bid price, high price, open price, volume, change percent, ask size and exchange.

6. The apparatus of claim 4 wherein the news object attribute is selected from a list comprising: headline and story.

7. The apparatus of claim 4 wherein the market object attribute is selected from a list comprising: last price, close price, price change, open price and change percent.

8. The apparatus of claim 4 wherein the order object attribute is selected from a list comprising: order status, open quantity, open value, value change, open percent, execution quantity, execution value, market value, execution percent, and exchange.

9. The apparatus of claim 4 wherein the account object attribute is selected from a list comprising: account type, investment value, unrealized cash, unrealized account, open investment, cash value, account value, unrealized investment, account description, and open cash.

10. The apparatus of claim 4 wherein the email object attribute is selected from a list comprising: sender address, message, subject.

11. The apparatus of claim 4 wherein the call object attribute is selected from a list comprising: pick up, hang up and answer.

12. The apparatus of claim 4 wherein the date/time object attribute is selected from a list comprising: start date, end date, date, recurrence pattern, recurrence day, start time, end time, time, and recurrence frequency.

13. The apparatus of claim 1 wherein the attribute comparison is selected from a group of attribute comparisons comprising: (a) >=, <=, >, <, =, and !=; (b) is, is not, has, has not, contains, contains not, exists, and not exist; and (c) on, at, before, and after.

14. The apparatus of claim 1 wherein the comparison value is selected from a group of comparison values comprising: number, string and date/time.

15. The apparatus of claim 1 wherein the plurality of action selections include: audio, popup, call, order, email, page, print, and fax.

16. The apparatus of claim 15 wherein the audio action selection is made from a list comprising: audio sound and text to be synthesized.

17. The apparatus of claim 15 wherein the popup action selection is made from a list comprising: text and alternatives to be determined.

18. The apparatus of claim 15 wherein the call action selection is made from a list comprising: telephone number, call type, call subject and call message.

19. The apparatus of claim 15 wherein the order action selection is made from a list comprising: symbol, shares, order action, order type, price type, condition, and duration.

20. The apparatus of claim 15 wherein the email action selection is made from a list comprising: email address, email type, email subject, and email message.

21. The apparatus of claim 15 wherein the page action selection is made from a list comprising: telephone number and page message.

22. The apparatus of claim 15 wherein the print action selection is made from a list comprising: printer name, message or file.

23. The apparatus of claim 15 wherein the fax action selection is made from a list comprising: fax number and message or file.

24. The apparatus of claim 1 wherein the condition and the at least one action are part of an automated nested if-then-else logic instruction set.

25. The apparatus of claim 1 further comprising a means for evaluating the condition and for taking the at least one action without human intervention.

26. The apparatus of claim 1 further comprising a means for modifying any of the parameters and the actions via an Internet browser.

27. The apparatus of claim 1 further comprising a means for modifying any of the parameters and the actions via a voice-activated communication device.

28. The apparatus of claim 1 further comprising a means for modifying any of the parameters and the actions via a textual display device.

29. The apparatus of claim 1 further comprising a means for logging communications data generated by the apparatus.
